(19) United States
(12) Patent Application Publication
(10) Pub. No.: US 2007/0255704 A1
(43) Pub. Date: Nov. 1, 2007

(54) Method and system of de-identification of a record

(76) Inventors: Ock Kee Baek, Unionville (CA); Simona Cohen, Haifa (IL); Alex Melament, Kiryat Bialik (IL); Pnina Vortman, Haifa (IL)

Correspondence Address: Stephen C. Kaufman;IBM CORPORATION, Intellectual Property Law Dept., P.O. Box 218, Yorktown Heights, NY, 10598, US

(21) Appl. No.: 11/380,220

(22) Filed: Apr. 26, 2006

(51) Int. Cl. G06F 17/30

(52) U.S. Cl. 707/6

(57) ABSTRACT

A method and system of de-identification of a record (100) are provided. The method includes creating a vector of identification field values (201) of a record (100), searching unstructured data (205) of the record (100) for each identification field value of the vector (201), and de-identifying the identification field values (230) of the record (100). The step of creating a vector of identification field values (201) extracts the values from one or more structured portions (101) of the record (100). An action (202) is defined for each identification field to de-identify the identification field. The method may include defining a mapping (203) of unstructured portions (111, 112, 113, 114) of the record (100), and extracting the unstructured portions (111, 112, 113, 114) of the record (100), wherein the steps of searching and de-identifying are carried out on the extracted unstructured portions (205).

### FIELD OF THE INVENTION

This invention relates to the field of de-identification of a record. In particular, the invention relates to extracting personal information elements from unstructured portions of a record in order to remove identification information.

### BACKGROUND OF THE INVENTION

Privacy of information has become very important in many different fields. Privacy is an issue that is likely to last for some time, with serious implications for businesses, especially those that rely heavily on information systems and Internet technology.

The ease with which electronic data can be transmitted, together with the vital need for data and information to advance research, has brought about the need to protect the privacy of the entities whose data is used. For example, medical research requires patient data but a patient's privacy must be protected. To preserve a person's privacy, it must be ensured that the transferred information cannot be associated with any specific individual and also that only authorized individuals based on the informed consent have access to the personal information.

This privacy is achieved by disclosing only certain pieces of non-identifiable information. To ensure complete privacy, all data must go through the process known as de-identification in which any pieces of information which can be used to identify an entity (such as an individual, a group of individuals, a business entity, a government entity, or any organisation) are removed or replaced with non-identifiable information.

Several countries have already chosen to impose this concept through legislation (for example, the Health Insurance Portability and Accountability Act of 1996 (HIPAA) in the U.S.). The HIPAA in the US is specific to portability of health information and applicable to the healthcare industry only. The EU Privacy Directive for the European Union member countries or the PIPEDA (Personal Information Protection and Electronic Document Act) and FIPPA (Freedom of Information and Protection of Privacy Act) in Canada are broader and also rigid and applicable to all business entities across industries. Legislation in this area is progressing around the world.

Legislation that protects the privacy of individuals can vary greatly, depending on which part of the world is involved. Additionally, the type of information involved, the technologies required to identify this information, and the definition of privacy are continuously evolving. The combination of these factors presents a challenge when developing methods for the protection of privacy and de-identification.

An example target industry in which de-identification of documents is critical, is the healthcare and life sciences industry. Specifically, de-identification is required for the implementation of electronic patient records (EPR) and electronic health records (EHR) for the integration of de-identified personal health records for translational life sciences research. De-identification of a patient's personal data from medical records is a protective legal requirement imposed before medical documents can be used for research purposes or transferred to other healthcare providers (e.g., teachers, students, tele-consultations).

De-identification can be applied to other industries such as government, retail, financial, insurance, and manufacturing industries for de-identification of protected personal information attributes.

In the US, HIPAA defines “Protected Health Information” (PHI) fields that must be de-identified to protect the personal privacy of a patient. These information fields include the following fields with the action required:
Name: remove.
Addresses: remove, but name of State, County, City, Town can be kept depending on the size of the population and based on IRB (Institutional Review Board) decisions.
Dates (e.g., DoB, ADT (admissions, discharges, transfers), DoD): replace with age ranges, or keep year only, but on an exceptional case month can be also kept.
Certificate/license numbers: remove.
Diagnostic device ID and serial number: remove.
Biometric identifier (e.g., voice, finger print, iris, retina): remove.
Full-face photo or comparable image: remove.
Social security number: remove.
Telephone numbers: remove. Area code and prefix can be kept only if geographical information is missing and also depending on the size of the population sharing the same area code or prefix.
Fax numbers: remove.
Electronic mail address: remove.
URL: remove.
IP address: remove.
Medical record number: remove.
Health plan number: remove.
Account numbers: remove.
Vehicle ID, serial number, and license plate number: remove.

The de-identification rules for the elements of PHI can change based on the privacy policies of individual business entities and the Institutional Review Board decisions. For example, the state and city out of the address can be kept as long as the population of the city is more than 20,000, and a date of birth can be converted to an age range if the person is 89 years or younger.

Existing methods of locating identifying personal information that can be directly used to identify a specific individual, or non-personal information (e.g. 90 years of age) that can be used indirectly to identify a specific individual, generally use natural language processing and use complex methods that require name repositories, location repositories, dictionaries, and other taxonomies that will help to detect whether a specific “word” can be used directly or indirectly to identify a person. These methods need sophisticated information retrieval techniques, must resolve ambiguity, and are required for imbedding relatively heavy processing and algorithms. Large repositories of names are required from all around the world as the population in every country today is heterogeneous as a result of large immigration.

### SUMMARY OF THE INVENTION

According to a first aspect of the present invention there is provided a method of de-identification of a record, comprising: creating a vector of identification field values of a record; searching unstructured data of the record for each identification field value of the vector; and de-identifying the identification field values of the record. The unstructured data may be portions of a structured, semi-structured, or unstructured record.

In an embodiment of the present invention, the step of creating a vector of identification field values extracts the values from one or more structured portions of the record. The one or more structured portions of the record may be independent of the unstructured data of the record, for example in a different file format. Alternatively, the one or more structured portions of the record may be combined with the unstructured data of the record.

The method also preferably includes defining an action for each identification field to de-identify the identification field. An action to be applied to an identification field may be, for example, to erase, encrypt, cloak, scramble, replace with a derived value, etc.

In one embodiment, the method includes defining a mapping of unstructured portions of the record; extracting the unstructured portions of the record; and wherein the steps of searching and de-identifying are carried out on the extracted unstructured portions. The method may also include re-mapping the de-identified unstructured portions to the record.

A measure of re-identification risk of a record may be defined as the level of difficulty of inferring information in a record to specific entities. A measure of completeness may be defined as the percentage of information in a record that is not de-identified. The measure of re-identification and the measure of completeness may be used to de-identify a minimum number of identification field values in a record.

According to a second aspect of the present invention there is provided a method comprising: extracting identification field values from a record; defining a set of conversion actions with a conversion action for each identification field; storing a first set of information of the identification field values and the set of conversion actions; and storing a second set of information of the record with converted identification field values; wherein the record can be re-identified using the first and second sets of information.

The first and second sets of information may be stored securely for access only by authorised users or stored encrypted using cryptography and the decryption keys available only to authorised users.

According to a third aspect of the present invention there is provided a computer program product stored on a computer readable storage medium for de-identifying a record, comprising computer readable program code means for performing the steps of: creating a vector of identification field values of a record; searching unstructured data of the record for each identification field value of the vector; and de-identifying the identification field values of the record.

According to a fourth aspect of the present invention there is provided a system for de-identification of a record, comprising: a tool for discovering identification field values of a record; a search engine for searching unstructured data of the record for each identification field value; and a converter for de-identifying the identification field values of the record.

The converter may apply an action defined for each identification field. The tool for discovering may be configured for discovering identification field values in one or more structured portions of the record. The one or more structured portions of the record may be independent of the unstructured data of the record. Alternatively, the one or more structured portions of the record may be combined with the unstructured data of the record.

In one embodiment, the system may also include: a pointer for mapping of unstructured portions of the record; an extractor for extracting the unstructured portions of the record; and a memory for storing the unstructured portions of the record; wherein the search engine and converter are applied to the stored unstructured portions of the record.

According to a fifth aspect of the present invention there is provided a method of providing a service over a network, the service comprising: creating a vector of identification field values of a record; searching unstructured data of the record for each identification field value of the vector; and de-identifying the identification field values of the record.

This present invention provides a method to parse unstructured records, extract identification field values embedded in the natural language text documents, and anonymize them as a means to de-identify the records.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIGS. 1A and 1B are schematic representations of a record to which a method in accordance with the present invention may be applied;

FIG. 2 is a schematic representation of a method in accordance with the present invention;

FIG. 3 is a block diagram of a computer system in which the present invention may be implemented;

FIG. 4 is a block diagram of a computer system showing components in accordance with the present invention;

FIGS. 5A and 5B are flow diagrams of methods of in accordance with the present invention; and

FIG. 6 is a flow diagram of a method in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The described method and system use the values of the fields which can identify an entity (identification fields) as a basic taxonomy vector. The process searches free text and unstructured information in a record for the appearance of any of the identification field values. This solution aims to ensure that no private information that can directly identify a person or an entity, or no other information that can indirectly identify a person or an entity (e.g. a 95 year old male in Haifa) appears anywhere in the record.

Thus, for every record, the taxonomy vector is generated dynamically from the identification fields. All free text in the record is searched against the taxonomy vector. In addition, a static taxonomy which contains potential nicknames or descriptors that are well known is created and can be used in a similar way.

A record may take many different forms. In some instances a record relates to a single entity, for example, a person, an organisation, etc. In other instances, a record may relate to more than one entity and identification field values in the record may identify one or more of the entities. Records can occur in different industries or relate to different forms of information relating to the entity. For example, the information may be medical, financial, business, government, etc.

A record generally includes one or more structured portions and one or more unstructured portions. In this way a record may be structured, semi-structured, or unstructured. The structured portions may present data in an ordered manner and the unstructured portions may be free text or data.

The unstructured portions may be separate from the structured portions and may not reside in the same portion of the record. For example, the structured portions may be represented as a CSV (comma-separated values) file, or in an XML (extended mark-up language).

On the other hand, the structured and unstructured data may be intermingled or combined. For example, an XML document with structured parts and unstructured parts, namely an XML element with free text under it.

The structured portions of a record can take different forms. For example, these may take the following forms, however other structured formats may also be envisaged:
a structured database;
a CSV file;
an XML element of an XML file; or
a DICOM (digital imaging and communications in medicine) header referencing free-form fields and image data of a DICOM file.

As the record has unstructured portions, a definition of where the unstructured portions are in the record is required.

For example:

if the unstructured portions are in an XML document, the definitions will be in XPath;
if the unstructured portions are in a database, the definitions will denote tables and column names that include unstructured portions;
if the unstructured portions are in a CSV file, the definitions will denote the positions that include unstructured portions; or
if the unstructured portions are in a DICOM file, the definitions will be DICOM tags where the unstructured portions reside.

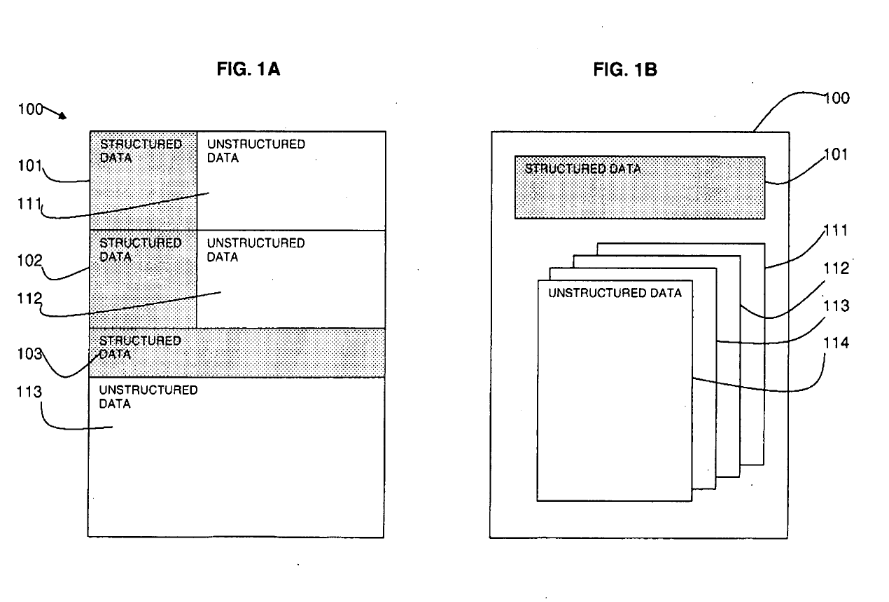

Referring to FIG. 1A, a schematic representation of a record 100 is shown. The record includes at least one structured portion 101, 102, 103 and at least one unstructured portion 111, 112, 113. FIG. 1B shows an alternative schematic representation of a record 100 with a single structured portion 101 and multiple unstructured portions 111, 112, 113, 114 forming the body of the record 100. The structured portion 101 may be in a different file format to the unstructured portions 111, 112, 113, 114.

As an example, a record may be a medical record with unstructured portions in the form of a patient chart, admission record, discharge summary, diagnostic report, referral letter, etc.

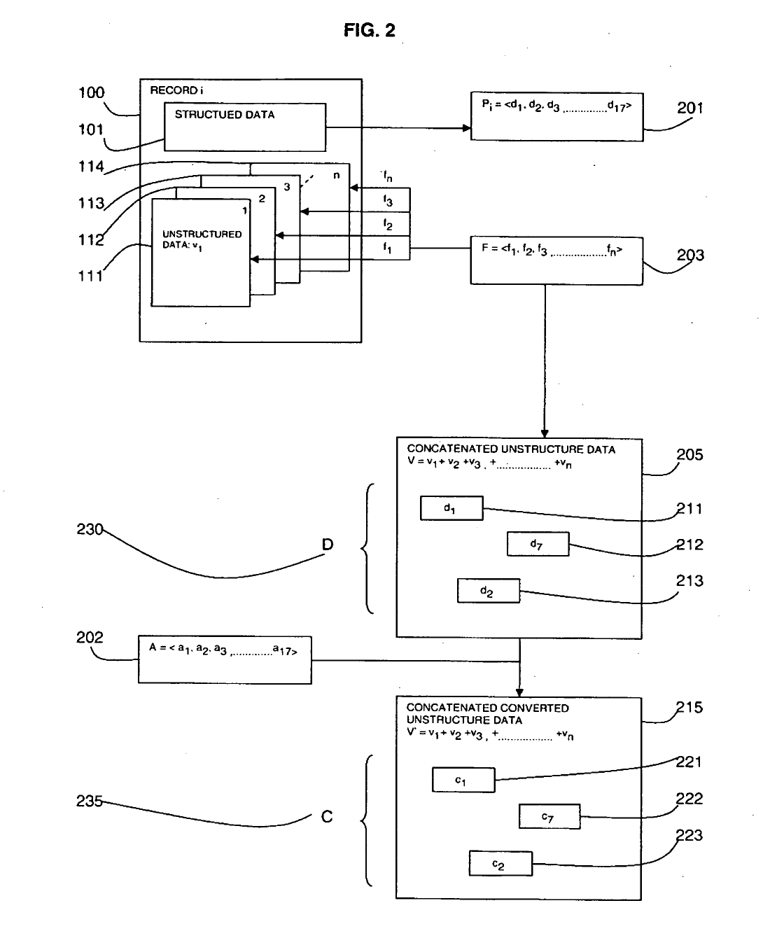

Referring to FIG. 2, a schematic representation of the described method is provided using a record 100 as depicted in FIG. 1B.

The values of identification fields are extracted from one or more structured portions 101 of the record i 100. The identification fields may be defined in accordance with legislation (such as Protected Health Information (PHI) defined by HIPAA), or may be defined for a particular application. When identification fields are presented in a structured format, such as in relational, rectangular, XML-tagged, tabular, and comma-separated, they can be extracted by a user. The extraction can be carried out programmatically with a configurable extraction tool.

If there are multiple records which have the same format of structured portions, an extraction tool can be configured to extract the identification field values for each record programmatically.

A record may relate to a single entity (such as a patient's medical report), or to more than one entity (such as a banking report for a joint account held by two or more persons). The identification field values are the actual names, address information, dates, identification numbers, etc. from which an entity can be identified.

As the identification field values are being extracted from the structured portion 101, a taxonomy vector 201 is generated and updated.

This vector is defined as Pᵢ−<d₁, d₂, d₃, . . . d₁₇>

where Pᵢ represent the vector 201 created for record i 100 for all its identification fields (for example, the 17 PHI fields); and
where dⱼ represents the value of field j of the identification fields.

The action to be taken on each identification field is also defined. This may be defined for a single record, or may be defined generally for a group of records. The action vector 202 is defined as:
A=<a₁, a₂, a₃, . . . a₁₇>
where aⱼ is the action to be taken on the identification field value dⱼ.
   This action vector 202 defines rules that will be used to decide on the action required for each field. The action may depend on the identification field and may be, for example, one of the actions erase, encrypt, cloak, scramble, etc.

De-identification replaces entity-specific identifiers (e.g., entity's name, age, gender, etc.) with non-specific markers, such as a “*” or “research patient”. De-identification destroys some of the worth of the data (for example, if the patient's age is removed this may limit use of the data). Anonymization goes further than de-identification and attempts to replace the sensitive fields with “like” values that obscure the identity of the entity. Such substitution values are typically drawn from a population statistic/curve (e.g., a Gaussian distribution, etc.). The action vector 202 defines this substitution or conversion.

As a separate step which may be carried out simultaneously, prior to, or after the step of discovering the values of the vector 201, a schema mapping 203 is defined pointing to all the unstructured portions 111, 112, 113, 114 of the record i 100.

The schema mapping 203 is defined for all unstructured portions 111, 112, 113, 114 of the medical record i 100. The schema mapping 203 is defined by defining a collection of mapping:
F=<f₁, f₂, f₃, . . . fₙ,>
where F is the set of all unstructured portions 1, 2, 3, . . . n of the record.
   For example, f₁ is the mapping to unstructured portion 1 (111), f₂) is the mapping to unstructured portion 2 (112), f₃ is the mapping to unstructured portion 3 (113), and fₙ is the mapping to unstructured portion n (114).

The mapping function fₙ is represented according to the record schema structure.

In the case the record is presented in XML, fₙ is the XPath format of the attribute. The term XPaths refers to the paths in XML documents that lead to specific fields. As an example, Clinical Document/recordTarget/patientRole/patientPatient/Name/family presents the family name of the person and gives the exact location of the attribute.

In the case the record is presented in a database, the mapping function fₙ will denote tables and column names that include unstructured portions. If the record is a CSV file or tabular file, the mapping function fₙ will denote the positions that include unstructured portions. If the record is a DICOM file, the mapping function fₙ will be DICOM tags where the unstructured portions reside.

In a next stage of the described method, the unstructured portions are extracted to generate the unstructured information 205 for record i. This is done by using the mapping function F 203 to extract the unstructured portions 1, 2, 3 . . . n of the medical record i 100. To simplify the process, all unstructured information is concatenated and stored in memory while maintaining the begin/end position of each unstructured portion and the index of the attribute it represents.

The unstructured information 205 is defined as:
V=v₁+v₂+v₃,+ . . . +vₙ,
where vₙ, is the value of the unstructured portion n that is identified by fₙ.
   The unstructured information V 205 is stored in memory and contains all the information from the unstructured portions 111, 112, 113, 114 of the record i 100.

Identification field values d 211, 212, 213 are contained in the unstructured information V 205. For example, a patient's name may occur numerous times in a medical record in unstructured portions such as the patient chart, admission record, patient diagnostic report, etc.

The unstructured information V 205 is searched for each entry of the vector 201 Pᵢ for record i presented as dⱼ.

The identification field values 230 in the unstructured information V 205 are defined as D and may take the form of, for example:
D=<d₁, d₂, d₁, d₆, d₈, d₂, . . . >

The configured action aⱼ as defined for each specific identification field in action vector A 202 is carried out. In case the action desired is to erase the value, the same action will apply to the value within the unstructured information V 205. In case the action desired is to encrypt the value, the same action will apply to the value within the unstructured information V 205. In case the action desired is to substitute the value with a derived value, (e.g. substituting date of birth with age range), the same action will apply to the value within the unstructured information V 205.

The converted identification field values 235 in the unstructured information V 205 are defined as C and, following the above example for D, may take the form of:
C=<c₁, c₂, c₁, c₆, c₈, c₂, . . . >
where dⱼ*aⱼ=cⱼ

The unstructured information V 205 is searched for all values in the taxonomy vector Pᵢ 201 for the values dⱼ and the values are converted to cⱼ by carrying out the required action aⱼ for the identification field. The updated unstructured information V′ 215 has all the identification values dⱼ 211, 212, 213 converted to cⱼ 221, 222, 223 and thus is de-identified.

The record i 100 is updated using the unstructured portions 1, 2, 3, . . . n 111, 112, 113, 114 including the converted identification field values cⱼ 221, 222, 223 of the unstructured information V′ 215 from memory to the associated attributes as defined by the mapping function F 203. Each unstructured portion is replaced with the converted and anonymized unstructured portion according to the above algorithm.

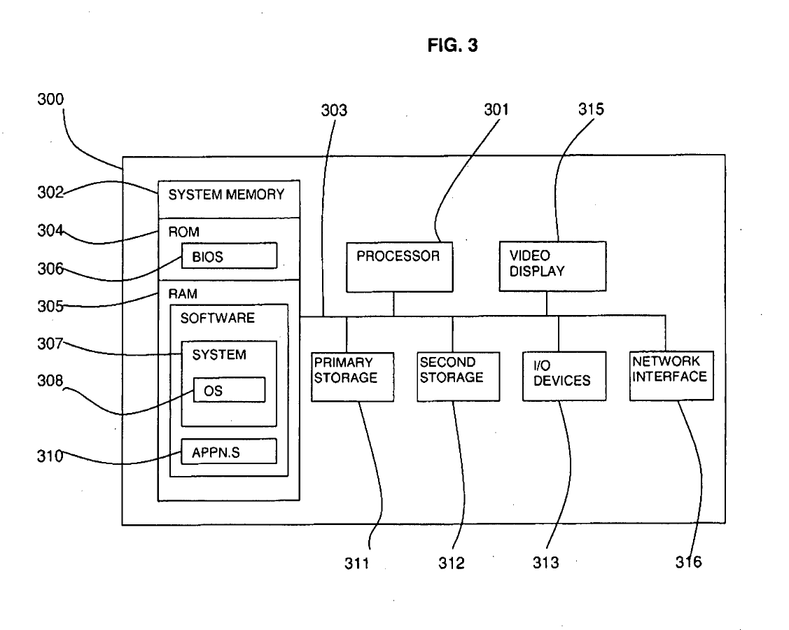

Referring to FIG. 3, an exemplary system for implementing the invention includes a data processing system 300 suitable for storing and/or executing program code including at least one processor 301 coupled directly or indirectly to memory elements through a bus system 303. The memory elements can include local memory employed during actual execution of the program code, bulk storage, and cache memories which provide temporary storage of at least some program code in order to reduce the number of times code must be retrieved from bulk storage during execution.

The memory elements may include system memory 302 in the form of read only memory (ROM) 304 and random access memory (RAM) 305. A basic input/output system (BIOS) 306 may be stored in ROM 304. System software 307 may be stored in RAM 305 including operating system software 308. Software applications 310 may also be stored in RAM 305.

The system 300 may also include a primary storage means 311 such as a magnetic hard disk drive and secondary storage means 312 such as a magnetic disc drive and an optical disc drive. The drives and their associated computer-readable media provide non-volatile storage of computer-executable instructions, data structures, program modules and other data for the system 300. Software applications may be stored on the primary and secondary storage means 311, 312 as well as the system memory 302.

The computing system 300 may operate in a networked environment using logical connections to one or more remote computers via a network adapter 316.

Input/output devices 313 can be coupled to the system either directly or through intervening I/O controllers. A user may enter commands and information into the system 300 through input devices such as a keyboard, pointing device, or other input devices (for example, microphone, joy stick, game pad, satellite dish, scanner, or the like). Output devices may include speakers, printers, etc. A display device is also connected to system bus 303 via an interface, such as video adapter 315.

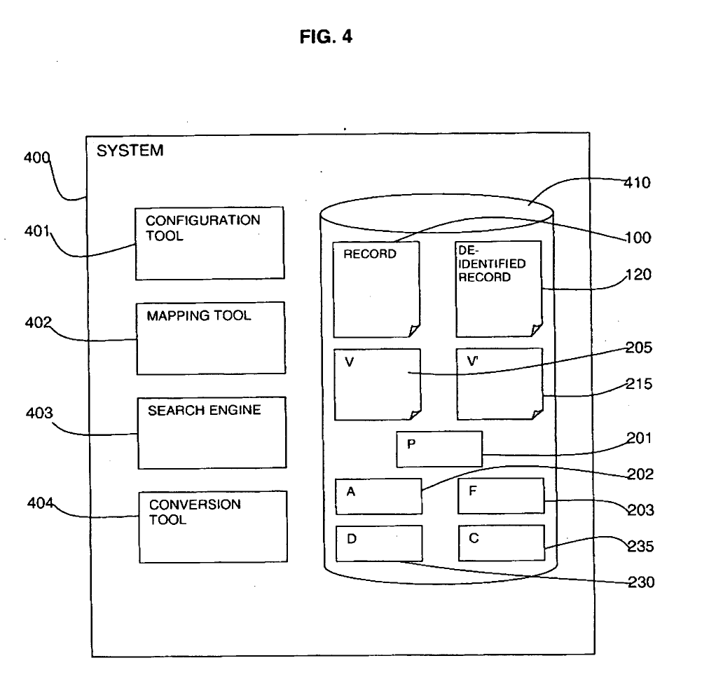

Referring to FIG. 4, a block diagram shows a simplified computer system 400 implementing the described system. The system 400 includes a configuration tool 401 for extracting the identification field values, a mapping tool 402 for mapping the unstructured portions of a record, a search engine 403 for searching for identification field values, and a conversion tool 404 for converting the identification values. These tools 401-404 may comprise hardware or software components and may be programmed to process data.

When the system 400 is in use data storage or memory 410 may store a record 100, the concatenated unstructured portions V 205 of the record, the converted concatenated unstructured portions V′ 215 and the de-identified record 120. During processing the memory may include the vector of identification field values P 201, the mapping function F 203, the conversion action vector A 202, the subset of identification values D 230, and the subset of converted identification values C 235.

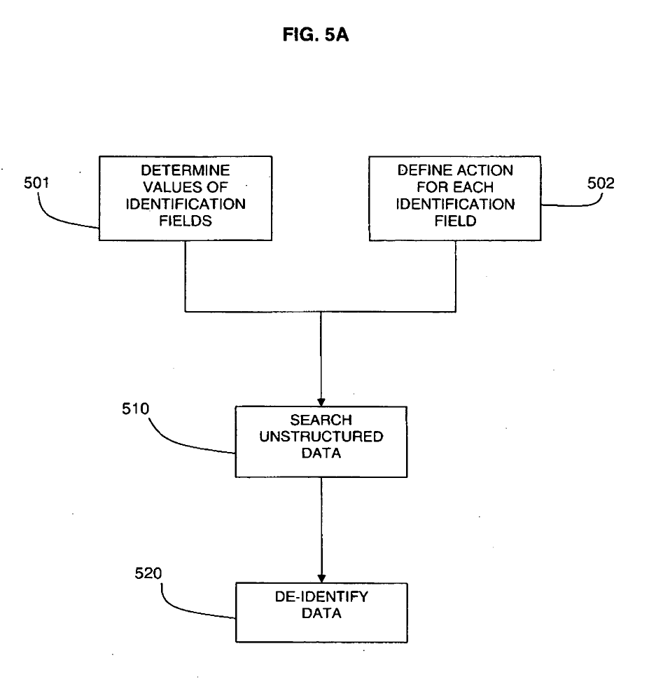

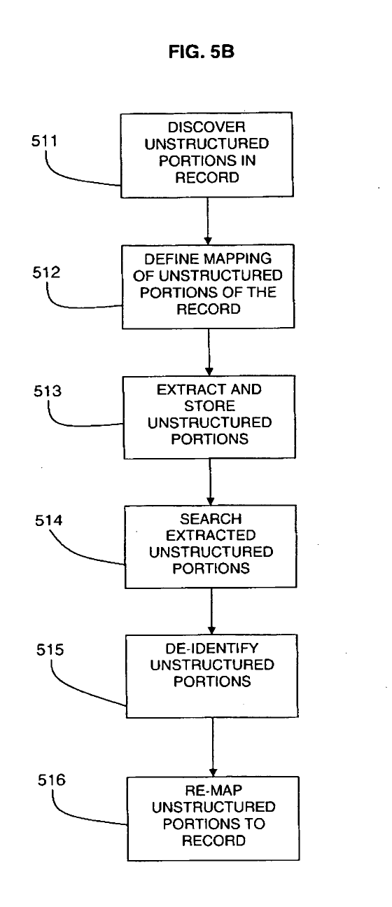

Referring to FIGS. 5A and 5B, the described method is shown in simplified steps of flow diagrams. In FIG. 5A the flow diagram shows the steps of determining the values 501 of identification fields of a record and defining the action 502 for each identification field. Unstructured data of the record is searched 510 for the field values, and the unstructured data is de-identified 520 by applying the defined action to each field value.

FIG. 5B expands the steps of searching 510 and de-identifying 520 of FIG. 5A, to include the following processing. The unstructured portions in a record are discovered 511, and a mapping of the unstructured portions is defined 512. The unstructured portions are extracted and stored 513. The stored unstructured portions are searched 514 for the identification field values determined in step 501. The unstructured portions are de-identified 515 by converting the identification field values. The de-identified unstructured portions are re-mapped 516 to the record resulting in a de-identified record.

De-identification methods and algorithms must be able to detect identifiers, but should not remove information that is necessary and does not break privacy policies. The method and system described above addresses the issue of privacy protection, but does not address the issue of removing minimal information.

To address this second goal, two measurements are defined:
Re-identificalion risk or confidentiality level—This is the level of difficulty to infer information to specific entities. Re-identification risk can be described by the number of entities that can be associated with the output information of the de-identification procedure. The higher the number is, the better the algorithm.
Completeness level—This is the percentage of the information that is not de-identified. The higher the percentage is, the better the algorithm, as it means there will be more information for extraction and mining. If all information is de-identified, it means that no data can be used for analysis; hence, the completeness level is 0%.

The above two measures can be used to de-identify a minimum number of identification field values in a record.

The above two measures are ultimately determined by the specific algorithms used for de-identification. For example, when scrubbing PHI values, it may be desirable to leave in the free-text the type of information that was scrubbed i.e. is it a patient name, a date of birth, an address. This makes the anonymized text more readable and increases the completeness level without decreasing the confidentiality level.

The described method can be extended to support the re-identification of a record by authorized people.

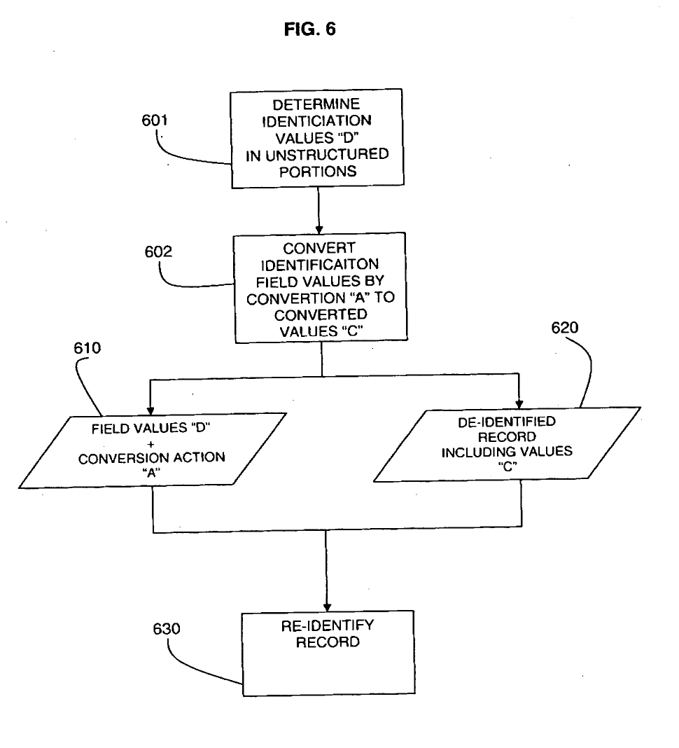

Referring to FIG. 6 a flow diagram is shown. The identification field values D are identified 601 in unstructured portions of a record. The identification field values D are converted 602 by using an action A resulting in converted values C.

A first set of information 610 is the combination of the identification field values D and the conversion method A. A second set of information is the de-identified record 620.

Neither the first set of information 610 nor the second set of information 620 contains information linking entities to their records. However, a record can be re-identified 630 using the first and second sets of information 610, 620.

This method can be summarised in the following steps:

1) Text is divided into short phrases;

2) Each phrase is converted by a one-way hash algorithm into a seemingly-random set of characters;

3) Threshold Piece 1 is composed of the list of all phrases, with each phrase followed by its one-way hash;

4) Threshold Piece 2 is composed of the text with all phrases replaced by their one-way hash values, and with high-frequency words preserved. (When a high-frequency “stop” word, such as a, an, the, or for, is encountered, it is left in place).

There are two methods to enable re-identification. One option is to generate a vector of the converted values C that corresponds to the field identification values D and then to store C and D in a secure zone that can only be accessed by authorized people. Another option is to use cryptographic technologies to generate the C vector from D and to save the private keys in a secured zone. In both cases C values replace D values in the record.

The described method and system create a relatively simple taxonomy vector for the identification field values and the taxonomy vector is used to search and identify those key words and values that are imbedded in unstructured text documents in a relatively simple and fast way without requiring any special computing resources or any specific prerequisite software or hardware.

The described method can be used as a first path to the more complex known methods using natural language processing, thereby reducing the processing required for those methods.

A method of de-identification and/or re-identification as described above may be provided as a service to a customer over a network

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A method of de-identification of a record, comprising:
creating a vector of identification field values of a record;
searching unstructured data of the record for each identification field value of the vector; and
de-identifying the identification field values of the record.

2. A method as claimed in claim 1, wherein creating a vector of identification field values extracts the values from one or more structured portions of the record.

3. A method as claimed in claim 2, wherein the one or more structured portions of the record are independent of the unstructured data of the record.

4. A method as claimed in claim 2, wherein the one or more structured portions of the record are combined with the unstructured data of the record.

5. A method as claimed in claim 1, including defining an action for each identification field to de-identify the identification field.

6. A method as claimed in claim 1, including:
defining a mapping of unstructured portions of the record;
extracting the unstructured portions of the record; and
wherein the steps of searching and de-identifying are carried out on the extracted unstructured portions.

7. A method as claimed in claim 6, including re-mapping the de-identified unstructured portions to the record.

8. A method as claimed in claim 1, wherein a measure of re-identification risk of a record is defined as the level of difficulty of inferring information in a record to specific entities.

9. A method as claimed in claim 1, wherein a measure of completeness is defined as the percentage of information in a record that is not de-identified.

10. A method as claimed in claim 8, wherein the measure of re-identification and the measure of completeness are used to de-identify a minimum number of identification field values in a record.

11. A method comprising:
extracting identification field values from a record;
defining a set of conversion actions with a conversion action for each identification field;
storing a first set of information of the identification field values and the set of conversion actions;
storing a second set of information of the record with converted identification field values;
wherein the record can be re-identified using the first and second sets of information.

12. A method as claimed in claim 11, wherein the first and second sets of information are stored securely for access only by authorised users.

13. A method as claimed in claim 11, wherein the first and second sets of information are stored encrypted using cryptography and the decryption key is available only to authorised users.

14. A computer program product stored on a computer readable storage medium for de-identifying a record, comprising computer readable program code means for performing the steps of:
creating a vector of identification field values of a record;
searching unstructured data of the record for each identification field value of the vector; and
de-identifying the identification field values of the record.

15. A system for de-identification of a record, comprising:
a tool for discovering identification field values of a record;
a search engine for searching unstructured data of the record for each identification field value; and
a converter for de-identifying the identification field values of the record.

16. A system as claimed in claim 15, wherein the tool for discovering is configured by a user for discovering identification field values in one or more structured portions of the record.

17. A system as claimed in claim 16, wherein the one or more structured portions of the record are independent of the unstructured data of the record.

18. A system as claimed in claim 16, wherein the one or more structured portions of the record are combined with the unstructured data of the record.

19. A system as claimed in claim 15, wherein the converter applies an action defined for each identification field.

20. A system as claimed in claim 15, including:
a pointer for mapping of unstructured portions of the record;
an extractor for extracting the unstructured portions of the record; and
a memory for storing the unstructured portions of the record;
wherein the search engine and converter are applied to the stored unstructured portions of the record.
